(19) United States
(12) Patent Application Publication
(10) Pub. No.: US 2007/0008271 A1
(43) Pub. Date: Jan. 11, 2007

(54) Liquid crystal display device, apparatus for driving the same, and method of driving the same

(75) Inventors: Ho-Suk Maeng, Seoul (KR); Pil-Mo Choi, Seoul (KR); Tae-Hyeong Park, Yongin-si (KR); Chul-Ho Kim, Seoul (KR); Seock-Cheon Song, Suwon-si (KR); Sang-Hoon Lee, Seoul (KR); Ung-Sik Kim, Suwon-si (KR); Keun-Woo Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/480,658

(22) Filed: Jul. 3, 2006

(30) Foreign Application Priority Data
Jul. 5, 2005 (KR) 2005-60051

(51) Int. Cl. G09G 3/36

(52) U.S. Cl. 345/98

(57) ABSTRACT

An LCD device includes an LCD panel, a source driving part, an operating part, a mean voltage generating part, and a pre-charging part. The LCD panel includes a switching element and a liquid crystal capacitor. The switching element is formed in a region defined by gate and source lines adjacent to each other. The liquid crystal capacitor is electrically connected to the switching element. The source driving part converts data signals into data voltages of analog type. The operating part determines a mean data signal of the data signals. The mean voltage generating part converts the mean data signal into a mean data voltage of analog type. The pre-charging part selectively applies the data voltages and the mean data voltage to the source lines, thereby improving an image display quality of the LCD device.

### CROSS REFERENCE OF RELATED APPLICATION

The present application claims priority from Korean Patent Application No. 2005-60051, filed on Jul. 5, 2005, the disclosure of which is hereby incorporated herein by reference in its entirety.

### BACKGROUND OF THE INVENTION

1. Field of the Invention

The present invention relates to a liquid crystal display (LCD) device, an apparatus for driving the LCD device and a method of driving the LCD device. More particularly, the present invention relates to an LCD device of pre-charge type, an apparatus for driving the LCD device, and a method of driving the LCD device.

2. Description of the Related Art

A liquid crystal display (LCD) device, in general, includes an LCD panel and a driving circuit part that applies driving signals to the LCD panel. The LCD panel includes a plurality of gate lines, a plurality of source lines, and a plurality of pixel parts. Each of the pixel parts is in a region defined by the gate and data lines adjacent to each other. A switching element, a liquid crystal capacitor, and a storage capacitor are in each of the pixel parts.

When a gate signal is applied to each of the gate lines, the switching element in the pixel parts is turned on so that a data signal that is from each of the source lines is applied to the liquid crystal capacitor. A data voltage corresponding to the data signal is stored in the liquid crystal capacitor and a storage capacitor. Therefore, a gray-scale corresponding to an image is displayed.

Data voltages corresponding to various levels are applied to the pixel parts to display gray-scales of the image. A margin for a storing time is required to display the image. In a pre-charge method, a pre-charge voltage having a predetermined level is applied to the source lines during a non-driving time period so that the liquid crystal capacitors of the LCD panel are pre-charged.

The pre-charge voltage is a voltage of a middle gray-scale, a white gray-scale, or a black gray-scale. However, when a difference of levels between the pre-charge voltage and the data voltage corresponding to the image is large, the image display quality of the LCD device is deteriorated.

### SUMMARY OF THE INVENTION

The present invention provides an LCD device of pre-charge type, an apparatus for driving the above-mentioned LCD device, and a method of driving the LCD device.

In accordance with one embodiment of the present invention, an LCD device is provided, the device including an LCD panel, a source driving part, an operating part, a mean voltage generating part, and a pre-charging part. The LCD panel includes a switching element and a liquid crystal capacitor. The switching element is formed in a region defined by gate and source lines adjacent to each other. The liquid crystal capacitor is electrically connected to the switching element. The source driving part converts data signals into data voltages of analog type. The operating part determines a mean data signal of the data signals. The mean voltage generating part converts the mean data signal into a mean data voltage of analog type. The pre-charging part selectively applies the data voltages and the mean data voltage to the source lines.

The pre-charging part may apply a mean data voltage of data signals of an (n+1)-th gate line to the source lines when an n-th gate line is not activated, and may apply data voltages of the data signals of the (n+1)-th gate line to the source lines when the (n+1)-th gate line is activated.

The operating part may determine the mean data signal as a mean of most frequent data signals of the data signals of the (n+1)-th gate line.

The LCD device may further include a memory storing the data signals by a predetermined unit, and the operating part may determine the mean data signal using the data signals of the (n+1)-th gate line stored in the memory.

The source driving part may further include a latch part that temporarily stores the data signals, and the operating part may determine the mean data signal using the data signals of the (n+1)-th gate line stored in the latch part.

The source driving part may divide the data voltages into a plurality of groups, and output each of the groups.

The pre-charging part may apply a mean data voltage of data signals of an n-th gate line to the source lines when the n-th gate line is not activated, and may apply data voltages of the data signals of an (n+1)-th gate line to the source lines when the (n+1)-th gate line is activated.

The operating part may determine the mean data signal as a mean of most frequent data signals of the data signals of the n-th gate line.

In accordance with another embodiment of the present invention, an apparatus for driving an LCD device is provided, the apparatus including a source driving part, an operating part, a mean voltage generating part and a pre-charging part. The LCD device includes an LCD panel having a display region in which a plurality of pixel parts are formed between adjacent gate and source lines, and a peripheral region surrounding the display region. The source driving part converts data signals into data voltages of analog type. The operating part determines a mean data signal of the data signals. The mean voltage generating part converts the mean data signal into a mean data voltage of analog type. The pre-charging part selectively applies the data voltages and the mean data voltage to the source lines.

In accordance with yet another embodiment of the present invention, a method of driving an LCD device is provided as follows. The LCD device includes an LCD panel having gate and source lines. A mean data voltage is generated corresponding to (n+1)-th data signals. The mean data voltage is applied to the source lines when an n-th gate line is not activated. Data voltages corresponding to the (n+1)-th data signals are applied to the source lines when an (n+1)-th gate line is activated.

The mean voltage may be generated by determining the mean data signal using the (n+1)-th data signals that are stored, and converting the mean data signal into a mean data voltage of analog type.

According to the present invention, a pre-charging voltage corresponding to various data signals is applied to the gate line, thereby improving an image display quality of the LCD device.

### BRIEF DESCRIPTION OF THE DRAWINGS

The above and other advantages of the present invention will become more apparent by describing in detail exemplary embodiments thereof with reference to the accompanying drawings, in which:

FIG. 1 is a plan view showing a liquid crystal display (LCD) device in accordance with one embodiment of the present invention;

FIG. 2 is a block diagram showing a main driving part shown in FIG. 1;

FIG. 3 is a block diagram showing a pre-charge method for driving the LCD device shown in FIG. 1;

FIG. 4 is a block diagram showing a pre-charge method for driving a source driving part in accordance with another embodiment of the present invention;

FIG. 5 is a plan view showing an LCD device in accordance with another embodiment of the present invention;

FIG. 6 is a block diagram showing a main driving part shown in FIG. 5;

FIG. 7 is a block diagram showing a pre-charge method for driving the LCD device shown in FIG. 5;

FIG. 8 is a block diagram showing a pre-charge method for driving a source driving part in accordance with another embodiment of the present invention;

FIG. 9 is a plan view showing an LCD device in accordance with another embodiment of the present invention;

FIG. 10 is a block diagram showing a main driving part shown in FIG. 9; and

FIG. 11 is a block diagram showing a pre-charge method for driving the LCD device shown in FIG. 9.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

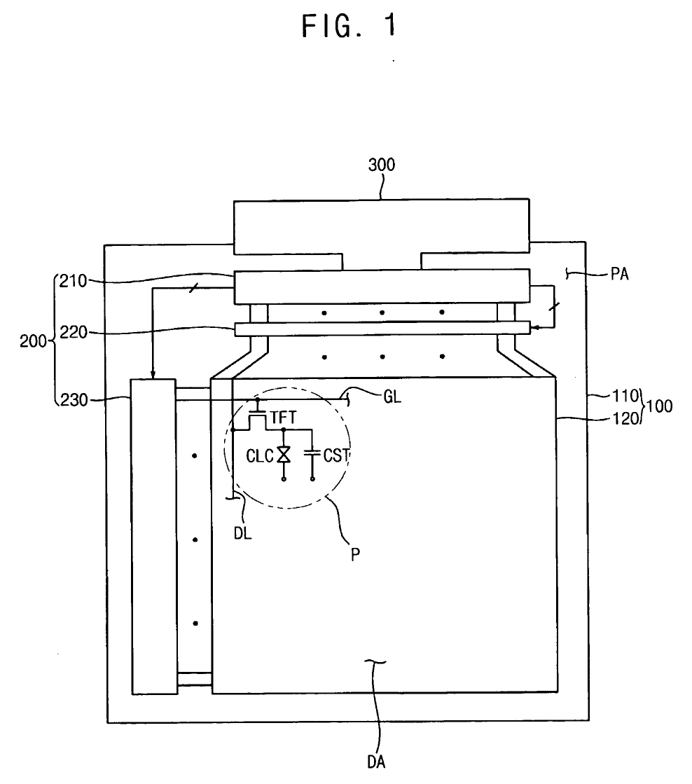

FIG. 1 is a plan view showing a liquid crystal display (LCD) device in accordance with one embodiment of the present invention.

Referring to FIG. 1, the LCD device includes an LCD panel 100, a driving unit 200 and a flexible printed circuit board (FPC) 300. An external device (not shown) is electrically connected to the driving unit 200 through the FPC 300.

The LCD panel 100 includes a lower substrate 110, an upper substrate 120 and a liquid crystal layer (not shown). The liquid crystal layer (not shown) is interposed between the lower and upper substrates 110 and 120. A display region DA and a peripheral region PA are defined on the LCD panel 100. The peripheral region PA surrounds the display region DA.

A plurality of source lines DL and a plurality of gate lines GL are formed in the display region DA. The gate lines GL cross the source lines DL. A plurality of pixel parts P is defined by the source and gate lines DL and GL adjacent to each other. A switching element TFT, a liquid crystal capacitor CLC, and a storage capacitor CST are formed in each of the pixel parts P. The liquid crystal capacitor CLC and the storage capacitor CST are electrically connected to the switching element TFT.

The driving unit 200 includes a main driving part 210, a pre-charging part 220, and a gate circuit part 230.

The main driving part 210 may be a chip in the peripheral region PA. The main driving part 210 generates driving signals for driving the pixel parts P based on control signals and data signals that are from the FPC 300. For example, the main driving part 210 may apply an (n+1)-th mean data voltage (A_D_n+1) corresponding to (n+1)-th data signals (D_n+1) to the pre-charging part 220.

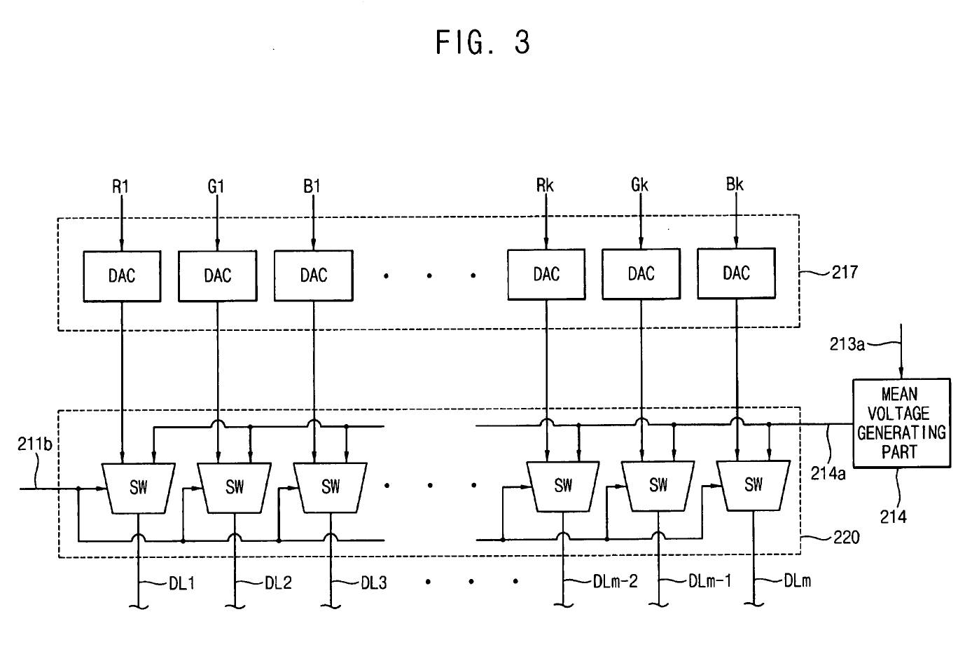

The pre-charging part 220 includes a plurality of switches SW (FIG. 3), and selectively outputs data voltages and mean data voltages. For example, when an n-th gate line is not activated, the pre-charging part 220 may apply the (n+1)-th mean data voltage (A_D_n+1) to the source lines DL. In addition, when an (n+1)-th gate line is activated, the pre-charging part 220 may apply the (n+1)-th data voltages (D_n+1) to the source lines DL.

Therefore, the LCD panel 100 is pre-charged by the (n+1)-th mean data voltage (A_D_n+1). That is, before the (n+1)-th data signals (D_n+1) are applied to (n+1)-th pixel parts (P_n+1) that are electrically connected to the (n+1)-th gate line, the (n+1)-th pixel parts (P_n+1) are pre-charged by the (n+1)-th mean data voltage (A_D_n+1) to increase a charging rate of the (n+1)-th pixel parts (P_n+1).

The gate circuit part 230 may be a chip in the peripheral region PA. The gate circuit part 230 applies a plurality of gate signals to the gate lines GL, respectively, based on the driving signals that are from the main driving part 210.

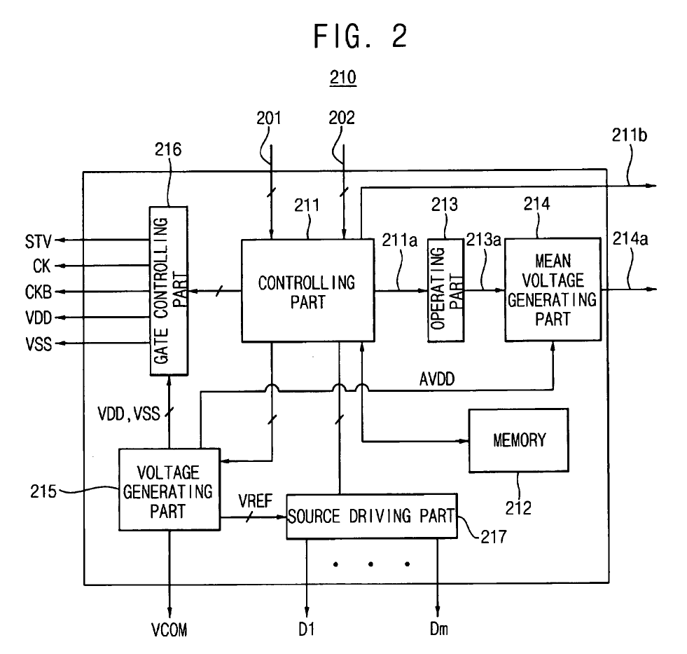

FIG. 2 is a block diagram showing a main driving part shown in FIG. 1.

Referring to FIGS. 1 and 2, the main driving part 210 includes a controlling part 211, a memory 212, an operating part 213, a mean voltage generating part 214, a voltage generating part 215, a gate controlling part 216, and a source driving part 217.

The controlling part 211 controls the main driving part 210 and the pre-charging part 220. For example, the controlling part 211 stores the data signals in the memory 212 based on the control signals from the external device (not shown). When the n-th data signal (D_n) is applied to the source lines DL, the controlling part 211 reads the (n+1)-th data signals (D_n+1), and applies the (n+1)-th data signals (D_n+1) to the operating part 213.

The n-th data signal (D_n) is a data signal corresponding to a 1H period of the n-th gate line that is electrically connected to the pixel parts P through the switching elements (TFT). The 1H period is a portion of a time period in one frame.

The operating part 213 operates the (n+1)-th mean data signal (A_D_n+1) of (n+1)-th data signals (D_n+1) based on the (n+1)-th data signals (D_n+1) that are from the controlling part 211.

For example, the mean data signal may be determined from the following Tables 1 and 2. Tables 1 and 2 represent mean data signals and data signals. In Table 1, LSB may range from 0000-1111. In Table 2, LSB may range from 000-111.

TABLE 1

Data Signal

| MSB | LSB | Mean Data Signal |
|---|---|---|
| 00 | xxxx | 001000 (8 gray-scale) |
| 01 | xxxx | 011000 (24 gray-scale) |
| 10 | xxxx | 101000 (40 gray-scale) |
| 11 | xxxx | 111000 (56 gray-scale) |

Referring to Table 1, when higher two bits (MSB) of most frequent data signals of the (n+1)-th data signals (D_n+1) is ‘00’, the (n+1)-th mean data signal (A_D_n+1) is ‘001000’ that is a mean value of ‘000000’ and ‘001111’. That is, the (n+1)-th mean data signal (A_D_n+1) becomes 8 gray-scale.

In Table 1, the data signals (DATA) of 18 bits may be divided into four regions, and a mean of gray-scales of each of the four regions may be the mean data signal (A_DATA).

TABLE 2

Data Signal

| MSB | LSB | Mean Data Signal |
|---|---|---|
| 000 | xxx | 000100 (4 gray-scale) |
| 001 | xxx | 001100 (12 gray-scale) |
| 010 | xxx | 010100 (20 gray-scale) |
| 011 | xxx | 011100 (28 gray-scale) |
| 100 | xxx | 100100 (36 gray-scale) |
| 101 | xxx | 101100 (44 gray-scale) |
| 110 | xxx | 110100 (52 gray-scale) |
| 111 | xxx | 111100 (60 gray-scale) |

Referring to Table 2, when higher three bits (MSB) of most frequent data signals of the (n+1)-th data signals (D_n+1) is ‘001’, the (n+1)-th mean data signal (A_D_n+1) is ‘001100’ that is a mean value of ‘001111’ and ‘001000’. That is, the (n+1)-th mean data signal (A_D_n+1) becomes 12 gray-scale.

In Table 2, the data signals (DATA) of 18 bits may be divided into eight regions, and a mean of gray-scales of each of the eight regions may be the mean data signal (A_DATA).

The mean voltage generating part 214 is a digital-analog transformer. The mean voltage generating part 214 outputs a mean data voltage that is an analog type based on the mean data signal (A_DATA) that is from the operating part 213. For example, when the (n+1)-th mean data signal (A_D_n+1) that corresponds to the (n+1)-th data signals (D_n+1) is ‘001100’, the mean voltage generating part 214 outputs the mean data voltage corresponding to the 12 gray-scale.

The mean data voltage that is outputted from the mean voltage generating part 214 is applied to the pre-charging part 220.

When the n-th gate line is not activated, the pre-charging part 220 applies the (n+1)-th mean data voltage (A_D_n+1) to the source lines DL based on the control signal so that the LCD panel 100 is pre-charged. When the (n+1)-th gate line is activated, the (n+1)-th data voltages (D_n+1) are applied to the pixel parts (P_n+1) to increase charging rates of the pixel parts (P_n+1).

The voltage generating part 215 generates driving voltages based on an externally provided electric power. The driving voltages include an analog driving voltage AVDD for the mean voltage generating part 214, gate voltages VSS and VDD for the gate controlling part 216, reference gamma voltages VREF for the source driving part 217, and a common voltage VCOM for the liquid crystal capacitor CLC of the LCD panel 100.

The gate driving part 216 applies gate control signals that are from the controlling part 211 and the gate voltages VSS and VDD to the gate circuit part 230. The gate control signals include a vertical start signal STV, a first clock signal CK, and a second clock signal CKB.

The source driving part 217 converts data signals that are read from the memory 212 based on the gamma reference voltage VREF into data voltages D1, D2, . . . Dm that are analog type. The source driving part 217 applies the data voltages D1, D2, . . . Dm to the source lines DL.

FIG. 3 is a block diagram showing a pre-charge method for driving the LCD device shown in FIG. 1.

Referring to FIGS. 1 and 3, the source driving part 217 converts data signals (R1, G1, B1, . . . , Rk, Gk, Bk) that are from the controlling part 211 into data voltages of the analog type using digital-analog transformers DAC. For example, one of the digital-analog transformers DAC transforms a first data signal R1 into the analog type data voltage based on the reference gamma voltages VREF that are from the voltage generating part 215.

The pre-charging part 220 selectively applies the data voltages that are from the source driving part 217 and mean data voltages 214a that are from the mean voltage generating part 214 to the source lines DL1, DL2, . . . DLm. For example, when the n-th gate line is not activated, the pre-charging part 220 applies the (n+1)-th mean data voltage (A_D_n+1) to the source lines DL1, DL2, . . . DLm based on a control signal 211b that is from the controlling part 211. When the n-th gate line is activated, the pre-charging part 220 applies the (n+1)-th data voltages (D_n+1) to the source lines DL1, DL2, DLm.

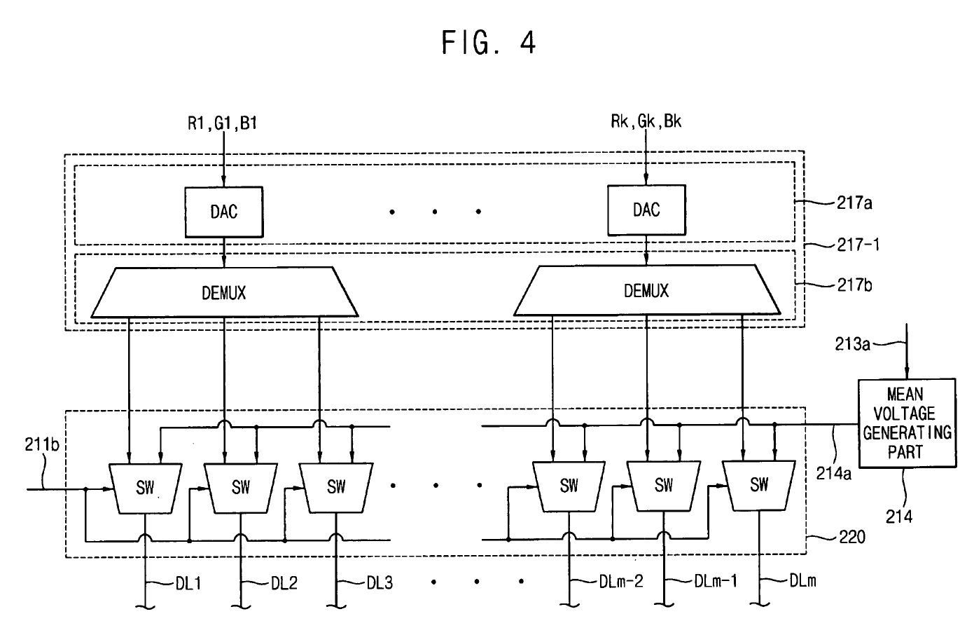

FIG. 4 is a block diagram showing a pre-charge method for driving a source driving part in accordance with another embodiment of the present invention. The LCD device of FIG. 4 is the same as in FIGS. 1 to 3 except for a source driving part. Thus, the same reference numerals will be used to refer to the same or like parts as those described in FIGS. 1 to 3 and further explanations concerning the above elements will be omitted.

Referring to FIGS. 2 and 4, a controlling part 211 applies the data signals that are grouped into a plurality of groups and correspond to a 1H period of a frame to a source driving part 217-1.

In one example, data signals (R1, G1, B1, . . . , Rk, Gk, Bk) are grouped into a red data group, a green data group, and a blue data group. The data groups may be applied to the source driving part 217-1, in sequence. For example, the red data signals (R1, R2, . . . Rk) may be first applied to the source driving part 217-1, then the green data signals (G1, G2, . . . Gk), and afterwards the blue data signals (B1, B2, . . . Bk). Therefore, the number of digital-analog transformers DAC 217a shown in FIG. 4 is about one third of the number of the digital-analog transformers DAC shown in FIG. 3.

The DAC 217a converts the red data signals (R1, R2, . . . Rk) into red data voltages of an analog type, and applies the analog type red data voltages to DEMUX part 217b. The DEMUX part 217b applies the red data voltages to first output terminals.

The DAC 217a converts the green data signals (G1, G2, . . . Gk) into green data voltages of an analog type, and applies the analog type green data voltages to the DEMUX part 217b. The DEMUX part 217b applies the green data voltages to second output terminals.

The DAC 217a converts the blue data signals (B1, B2, . . . Bk) into blue data voltages of an analog type, and applies the analog type blue data voltages to the DEMUX part 217b. The DEMUX part 217b applies the blue data voltages to third output terminals.

The data voltages from the DEMUX part 217b are then applied to the pre-charging part 220.

The pre-charging part 220 selectively applies the data voltages that are from the source driving part 217-1 and the mean data voltages that are from the mean voltage generating part 214 to the source lines DL1, DL2, . . . DLm.

For example, the red data voltages that are from the source driving part 217-1 are applied to the source lines DL1, DL2, . . . DLm, and the green data voltages that are from the source driving part 217-1 are then applied to the source lines DL1, DL2, . . . DLm. In addition, the blue data voltages that are from the source driving part 217-1 are then applied to the source lines DL1, DL2, . . . DLm.

In FIG. 4, the source driving part 217-1 is a three multi-flexing type circuit. Alternatively, the source driving part 217-1 may be a six multi-flexing type circuit.

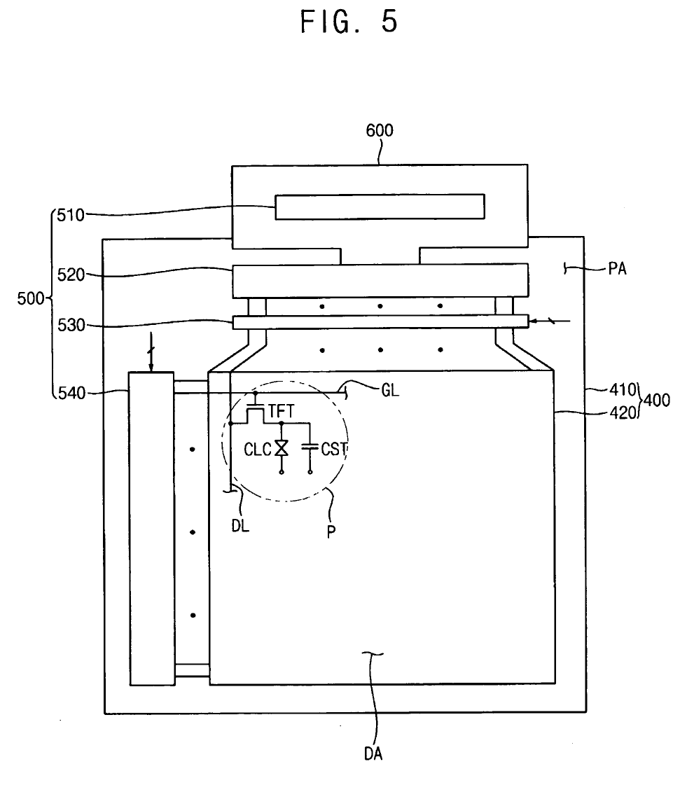

FIG. 5 is a plan view showing an LCD device in accordance with another embodiment of the present invention.

Referring to FIG. 5, the LCD device includes an LCD panel 400, a driving unit 500, and a flexible printed circuit board (FPC) 600. A main driving part 510 of the driving unit 500 is mounted on the flexible printed circuit board FPC 600.

The LCD panel 400 includes a lower substrate 410, an upper substrate 420, and a liquid crystal layer (not shown). The liquid crystal layer (not shown) is interposed between the lower and upper substrates 410 and 420. A display region DA and a peripheral region PA are defined on the LCD panel 400. The peripheral region PA surrounds the display region DA.

A plurality of source lines DL and a plurality of gate lines GL are formed in the display region DA. The gate lines GL cross the source lines DL. A plurality of pixel parts P is defined by the source and gate lines DL and GL adjacent to each other. A switching element TFT, a liquid crystal capacitor CLC, and a storage capacitor CST are formed in each of the pixel parts P. The liquid crystal capacitor CLC and the storage capacitor CST are electrically connected to the switching element TFT.

The driving unit 500 includes the main driving part 510, a source driving part 520, a pre-charging part 530, and a gate circuit part 540.

The main driving part 510 may be a chip on the FPC 600. The main driving part 510 generates driving signals for driving the pixel parts P based on control signals and data signals that are from an exterior source to the driving unit 500. For example, the main driving part 510 may apply an (n+1)-th mean data voltage (A_D_n+1) corresponding to (n+1)-th data signals (D_n+1) to the pre-charging part 530.

The source driving part 520 may be directly integrated in the peripheral region PA. Alternatively, the source driving part 520 may be a chip. The source driving part 520 converts the data signals into data voltages of an analog type based on driving signals that are from the main driving part 510, and applies the analog type data voltages into the source lines DL.

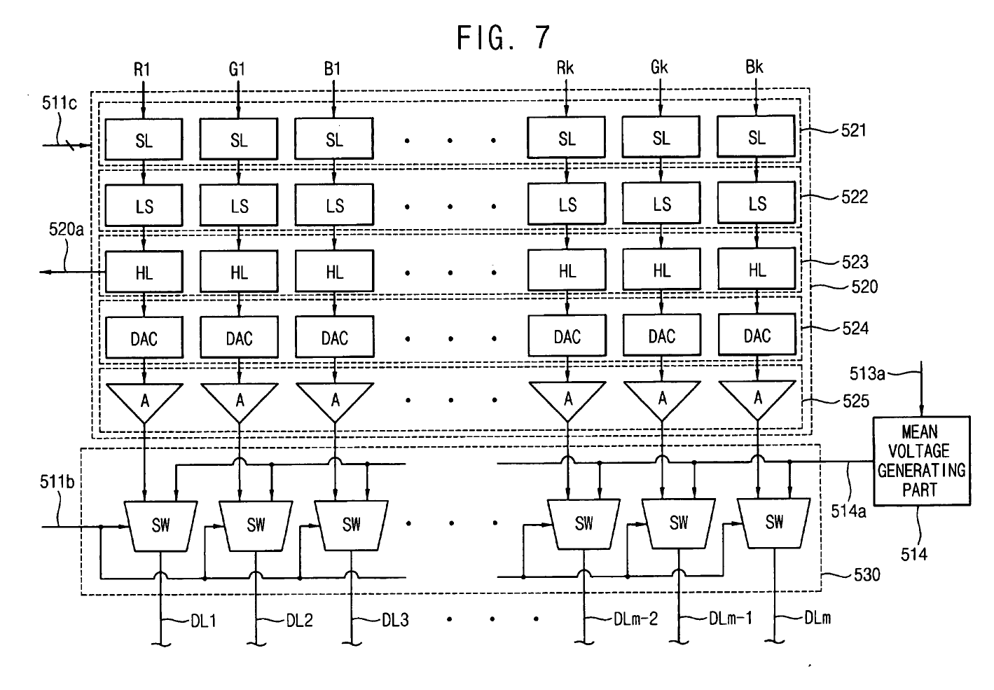

The pre-charging part 530 includes a plurality of switches SW (FIG. 7), and selectively outputs data voltages and mean data voltages. For example, when an n-th gate line is not activated, the pre-charging part 530 applies the (n+1)-th mean data voltage (A_D_n+1) to the source lines DL. When an (n+1)-th gate line is activated, the pre-charging part 530 applies the (n+1)-th data voltages (D_n+1) to the source lines DL.

Therefore, the LCD panel 400 is pre-charged by the (n+1)-th mean data voltage (A_D_n+1). That is, before the (n+1)-th data signal (D_n+1) is applied to (n+1)-th pixel parts (P_n+1) that are electrically connected to the (n+1)-th gate line, the (n+1)-th pixel parts (P_n+1) are pre-charged by the (n+1)-th mean data voltage (A_D_n+1) to increase a charging rate of the (n+1)-th pixel parts (P_n+1).

The gate circuit part 540 may be a chip in the peripheral region PA. The gate circuit part 540 applies a plurality of gate signals to the gate lines GL, respectively, based on the driving signals that are from the main driving part 510.

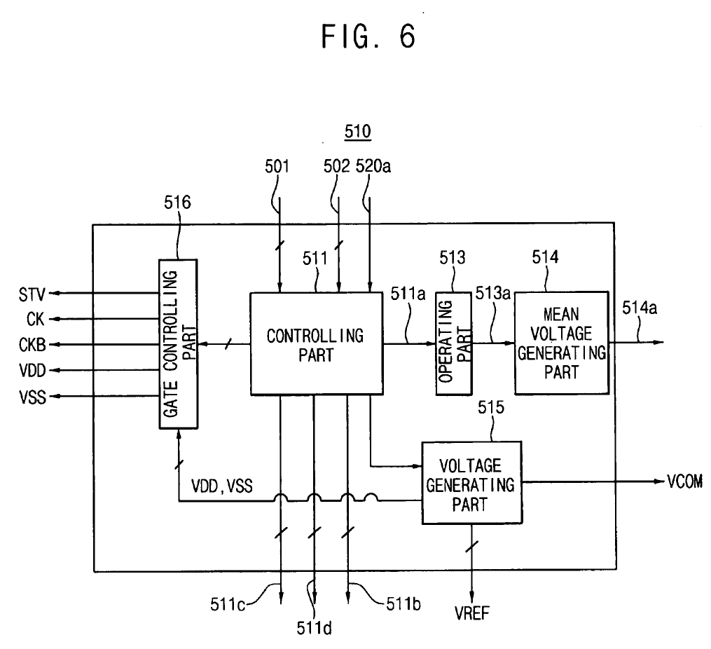

FIG. 6 is a block diagram showing a main driving part shown in FIG. 5.

Referring to FIGS. 5 and 6, the main driving part 510 includes a controlling part 511, an operating part 513, a mean voltage generating part 514, a voltage generating part 515, and a gate controlling part 516.

The controlling part 511 controls the main driving part 510 and the pre-charging part 530. For example, the controlling part 511 applies the data signals 511d to the source driving part 520 based on the control signals that are from the external device (not shown). The controlling part 511 reads the (n+1)-th data signal (D_n+1), and applies the (n+1)-th data signal (D_n+1) to the operating part 513. The (n+1)-th data signals (D_n+1) are data signals that are applied to (n+1)-th pixel parts that are electrically connected to the (n+1)-th gate line.

The operating part 513 operates the (n+1)-th mean data signal (A_D_n+1) of (n+1)-th data signals (D_n+1) based on the (n+1)-th data signals (D_n+1) that are from the controlling part 511. The (n+1)-th mean data signal (A_D_n+1) is a mean of most frequent data signals among the (n+1)-th data signals (D_n+1).

The method of operating the mean data signal of FIG. 6 is substantially the same as in FIGS. 1 to 3. Thus, further explanations concerning the above elements will be omitted.

The mean voltage generating part 514 is a digital-analog transformer. The mean voltage generating part 514 outputs a mean data voltage that is an analog type based on the mean data signal (A_DATA) that is from the operating part 513. The mean data voltage that is from the mean voltage generating part 514 is applied to the pre-charging part 530.

After the n-th gate line is activated, the pre-charging part 530 applies the (n+1)-th mean data voltage (A_D_n+1) to the source lines DL based on the control signal of the controlling part 511 so that the pixel parts (P_n+1) that are electrically connected to the (n+1)-th gate line is pre-charged. When the (n+1)-th gate line is thereafter activated, the (n+1)-th data voltages (D_n+1) are applied to the pixel parts (P_n+1) so that the pixel parts (P_n+1) are charged.

The voltage generating part 515 generates driving voltages based on an externally provided electric power. The driving voltages include an analog driving voltage AVDD for the mean voltage generating part 514, gate voltages VSS and VDD for the gate controlling part 516, reference gamma voltages VREF for the source driving part 520, and a common voltage VCOM for the liquid crystal capacitor CLC of the LCD panel 400.

The gate driving part 516 applies gate control signals that are from the controlling part 511 and the gate voltages VSS and VDD to the gate circuit part 540. The gate control signals include a vertical start signal STV, a first clock signal CK, and a second clock signal CKB.

FIG. 7 is a block diagram showing a pre-charge method for driving the LCD device shown in FIG. 5.

Referring to FIGS. 5 and 7, the source driving part 520 includes a sampling latch part 521, a level shift part 522, a holding latch part 523, a DAC part 524, and an output buffer part 525.

The sampling latch part 521 includes a plurality of sampling latches SL, and sequentially latches data signals (R1, G1, B2, . . . , Rk, Gk, Bk) that are from the controlling part 511. The data signals (R1, G1, B2, . . . , Rk, Gk, Bk) correspond to a 1H period of a frame.

The level shift part 522 includes a plurality of level shifters LS, and shifts levels of the data signals that are from the sampling latch part 521 into a predetermined level.

The holding latch part 523 includes a plurality of holding latches HL. The holding latch part 523 sequentially latches the data signals that are from the level shift part 522, and loads the latched data signals based on control signal 511b that is from the controlling part 511. The controlling part 511 reads the data signals that are latched by the holding latch parts 523, and the read data signals 520a are applied to the operating part 513. That is, the operating part 513 outputs a mean data signal based on the data signals that are latched by the holding latch part 523.

The digital analog converting part 524 includes a plurality of digital-analog transformers DAC, and converts the data signals that are loaded from the holding latch part 523 based on a reference gamma voltage VREF.

The output buffer part 525 includes a plurality of amplifiers A, and amplifies the data voltages that are outputted from the DAC part 523 at a predetermined level. The amplified data voltages are applied to the pre-charging part 530.

The pre-charging part 530 selectively applies the data voltages that are from the source driving part 520 and mean data voltages 514a that are from the mean voltage generating part 514 to the source lines DL1, DL2, . . . DLm. For example, when the n-th gate line is not activated, the pre-charging part 530 applies the (n+1)-th mean data voltage (A_D_n+1) to the source lines DL1, DL2, . . . DLm based on a control signal 511b that is from the controlling part 511. When the n-th gate line is activated, the pre-charging part 530 applies the (n+1)-th data voltages (D_n+1) to the source lines DL1, DL2, . . . DLm.

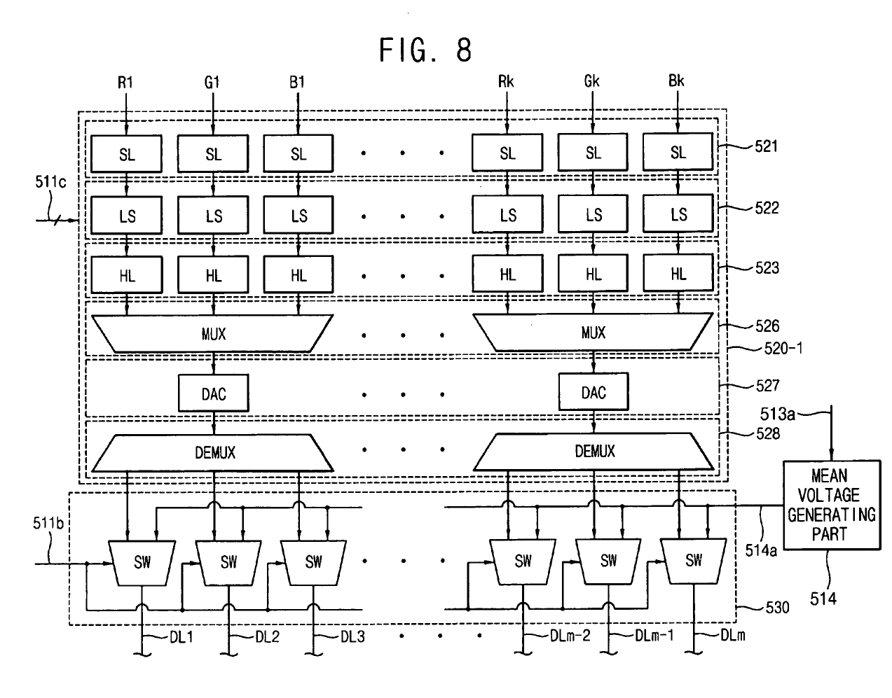

FIG. 8 is a block diagram showing a pre-charge method for driving a source driving part in accordance with another embodiment of the present invention.

Referring to FIGS. 5 and 8, the source driving part 520-1 includes a sampling latch part 521, a level shift part 522, a holding latch part 523, a MUX part 526, a DAC part 527, and a DEMUX part 528. The sampling latch part, the level shift part, and the holding latch part of FIG. 8 are substantially the same as in FIG. 7. Thus, the same reference numerals will be used to refer to the same or like parts as those described in FIG. 7 and further explanations concerning the above elements will be omitted.

The MUX part 526 groups data signals that are from the holding latch part 523 into a plurality of groups, and controls the data signals of each of the groups. In one example, the data signals (R1, G1, B2, . . . , Rk, Gk, Bk) that are from the holding latch part 523 are grouped into a red data group (R1, R2, . . . Rk), a green data group (G1, G2, . . . Gk), and a blue data group (B1, B2, . . . Bk). For example, the MUX part 526 applies the red data group (R1, R2, . . . Rk) to the DAC part 527, and then applies the green data group (G1, G2, . . . Gk) to the DAC part 527. In addition, the MUX part 526 then applies the blue data group (B1, B2, . . . Bk) to the DAC part 527. Therefore, the number of DAC shown in FIG. 8 is about one third of the number of the DAC shown in FIG. 7.

The DAC part 527 converts the red data signals (R1, R2, Rk) into red data voltages of an analog type, and applies the analog type red data voltages to DEMUX part 528. The DEMUX part 528 applies the red data voltages to first output terminals.

The DAC part 527 converts the green data signals (G1, G2, . . . Gk) into green data voltages of an analog type, and applies the analog type green data voltages to the DEMUX part 528. The DEMUX part 528 applies the green data voltages to second output terminals.

The DAC part 527 converts the blue data signals (B1, B2, . . . Bk) into blue data voltages of an analog type, and applies the analog type blue data voltages to the DEMUX part 528. The DEMUX part 528 applies the blue data voltages to third output terminals.

The data voltages that are from the DEMUX part 528 are applied to the pre-charging part 530.

The pre-charging part 530 selectively applies the data voltages that are from the source driving part 520a and the mean data voltages that are from the mean voltage generating part 514 to the source lines DL1, DL2, . . . DLm.

For example, the red data voltages that are from the source driving part 520a are applied to the source lines DL1, DL2, . . . DLm, and the green data voltages that are from the source driving part 520a are then applied to the source lines DL1, DL2, . . . DLm. In addition, the blue data voltages that are from the source driving part 520a are then applied to the source lines DL1, DL2, . . . DLm.

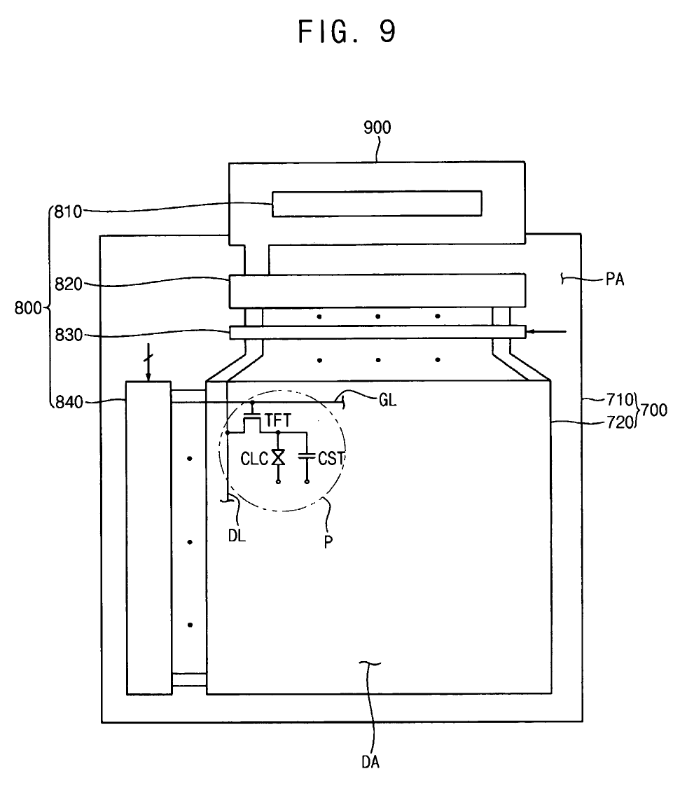

FIG. 9 is a plan view showing an LCD device in accordance with another embodiment of the present invention.

Referring to FIG. 9, the LCD device includes an LCD panel 700, a driving unit 900, and a flexible printed circuit board (FPC) 900. A main driving part 810 of the driving unit 900 is mounted on the flexible printed circuit board FPC 900.

The LCD panel 700 includes a lower substrate 710, an upper substrate 720, and a liquid crystal layer (not shown). The liquid crystal layer (not shown) is interposed between the lower and upper substrates 710 and 720. A display region DA and a peripheral region PA are defined on the LCD panel 700. The peripheral region PA surrounds the display region DA.

A plurality of source lines DL and a plurality of gate lines GL are formed in the display region DA. The gate lines GL cross the source lines DL. A plurality of pixel parts P is defined by the source and gate lines DL and GL adjacent to each other. A switching element TFT, a liquid crystal capacitor CLC, and a storage capacitor CST are formed in each of the pixel parts P. The liquid crystal capacitor CLC and the storage capacitor CST are electrically connected to the switching element TFT.

The driving unit 800 includes the main driving part 810, a shift register part 820, a pre-charging part 830, and a gate circuit part 840.

The main driving part 810 may be a chip on the FPC 900. The main driving part 810 generates driving signals for driving the pixel parts P based on control signals and data signals that are from an exterior source to the driving unit 800.

For example, the main driving part 810 applies an n-th mean data signal (A_D_n) corresponding to n-th data signals (D_n) to the pre-charging part 830. Before (n+1)-th data signals (D_n+1) are applied to the source lines DL, the n-th mean data signal (A_D_n) is applied to the source lines DL so that the LCD panel 700 is pre-charged.

The shift register part 820 may be directly integrated in the peripheral region PA. Alternatively, the shift register part 820 may be a chip. The shift register part 820 receives the data signals that are from the main driving part 810 to temporarily store the data signals for a 1H period. For example, when red, green, and blue data signals are applied from the main driving part 810 to the shift register part 820, the shift register part 820 shifts the red, green, and blue data signals, in sequence, so that the data signals corresponding to the 1H period are stored in the shift register part 820.

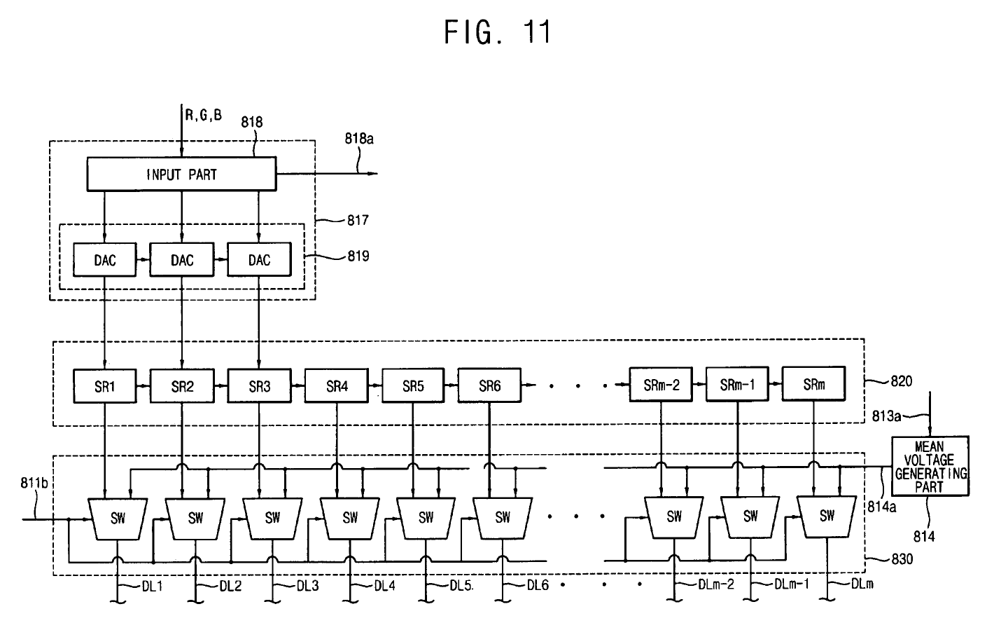

The pre-charging part 830 includes a plurality of switches SW (FIG. 11), and selectively outputs data voltages and mean data voltages. For example, when an n-th gate line is not activated, the pre-charging part 830 applies the n-th mean data voltage (A_D_n) to the source lines DL. When an (n+1)-th gate line is activated, the pre-charging part 830 applies the (n+1)-th data voltages (D_n+1) to the source lines DL.

Therefore, the LCD panel 700 is pre-charged by the n-th mean data voltage (A_D_n) to increase a charging rate of the (n+1)-th pixel parts P_n+1.

The gate circuit part 840 may be a chip in the peripheral region PA. The gate circuit part 840 applies a plurality of gate signals to the gate lines GL, respectively, based on the driving signals that are from the main driving part 810.

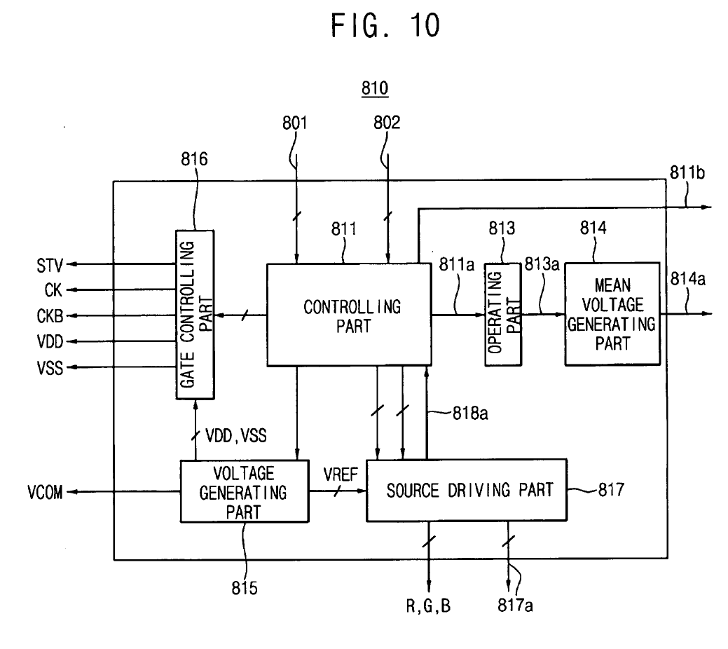

FIG. 10 is a block diagram showing a main driving part shown in FIG. 9.

Referring to FIGS. 9 and 10, the main driving part 810 includes a controlling part 811, an operating part 813, a mean voltage generating part 814, a voltage generating part 815, a gate controlling part 816, and a source driving part 817.

The controlling part 811 controls the main driving part 810 and the pre-charging part 830. For example, the controlling part 811 applies the data signals 811d to the source driving part 817 based on the control signals that are from the external device (not shown). The controlling part 811 reads n-th data signals (D_n) that are from the source driving part 817, and applies the read n-th data signal 818a to the operating part 813. The n-th data signals (D_n) are data signals that are applied to n-th pixel parts that are electrically connected to the n-th gate line.

The operating part 813 operates an n-th mean data signal (A_D_n) of the n-th data signals (D_n) based on the n-th data signals (D_n) that are from the controlling part 811. In one example, the n-th mean data signal (A_D_n) is a mean of most frequent data signals among the n-th data signals (D_n).

The method of operating the mean data signal of FIG. 10 is substantially the same as in FIGS. 1 to 3. Thus, further explanations concerning the above elements will be omitted.

The mean voltage generating part 814 is a digital-analog transformer. The mean voltage generating part 814 outputs a mean data voltage that is an analog type based on the mean data signal that is from the operating part 813. The mean data voltage that is from the mean voltage generating part 814 is applied to the pre-charging part 830.

When the n-th gate line is not activated, the pre-charging part 830 applies the n-th mean data voltage (A_D_n) to the source lines DL based on the control signal 811b of the controlling part 811 so that the pixel parts (P_n+1) that are electrically connected to the n-th gate line are pre-charged. When the (n+1)-th gate line is then activated, the (n+1)-th data voltages (D_n+1) are applied to the pixel parts (P_n+1) so that the pixel parts (P_n+1) are charged.

That is, the mean data voltage (A_D_n) of the n-th data signals (D_n) is pre-charged in the pixel parts (P_n+1) so that charging rates of the (n+1)-th data signals (D_n+1) are increased.

The voltage generating part 815 generates driving voltages based on an externally provided electric power. The driving voltages include an analog driving voltage AVDD for the mean voltage generating part 814, gate voltages VSS and VDD for the gate controlling part 816, reference gamma voltages VREF for the source driving part 817, and a common voltage VCOM for the liquid crystal capacitor CLC of the LCD panel 900.

The gate driving part 816 applies gate control signals that are from the controlling part 811 and the gate voltages VSS and VDD to the gate circuit part 840. The gate control signals include a vertical start signal STV, a first clock signal CK, and a second clock signal CKB.

FIG. 11 is a block diagram showing a pre-charge method for driving the LCD device shown in FIG. 9.

Referring to FIGS. 9 and 11, the source driving part 817 includes an input part 818 and a DAC part 819. The input part 818 applies data signals that are from the controlling part 811 to the DAC part 819.

The DAC part 819 includes a plurality of digital-analog transformers DAC, and converts the data signals from the input part 818 into data voltages of analog type. The data signals include red, green, and blue data signals R, G, and B, respectively. The DAC part 819 applies the analog type data voltages to a shift register part 820.

The shift register part 820 includes a plurality of shift registers SR1, SR2, . . . SRm), and shifts the data voltages that are from the DAC part 819, in sequence. For example, a first red data voltage R1, a first green data voltage G1, and a first blue data voltage B1 that are from the DAC part 819 are applied to a first shift register SL1, a second shift register SL2, and a third shift register SL3, respectively. A second red data voltage R2, a second green data voltage G2, and a second blue data voltage B2 that are from the DAC part 819 are applied to a fourth shift register SL4, a fifth shift register SL5, and a sixth shift register SL6 through the first, second, and third shift registers SL1, SL2, and SL3, respectively. More generally, a k-th red data voltage Rk, a k-th green data voltage Gk, and a k-th blue data voltage Bk that are from the DAC part 819 are applied to a (m⁻²)-th shift register SLm−2, a (m−1)-th shift register SLm−1, and an m-th shift register SLm, respectively.

When the data voltages are stored in the shift register part 820, the stored data voltages are applied to the pre-charging part 830.

The pre-charging part 830 selectively applies the data voltages that are from the shift register part 820 and mean data voltages 814a that are from the mean voltage generating part 814 to the source lines DL1, DL2, . . . DLm.

In one example, when the n-th gate line is not activated, the pre-charging part 830 applies the n-th mean data voltage (A_D_n) to the source lines DL1, DL2, . . . DLm based on a control signal 811b that is from the controlling part 811. When the (n+1)-th gate line is activated, the pre-charging part 830 applies the (n+1)-th data voltages (D_n+1) to the source lines DL1, DL2, . . . DLm.

Therefore, the n-th mean data voltage (A_D_n) of the n-th data signals (D_n) is pre-charged in the pixel parts (P_n+1) so that charging rates of the (n+1)-th data signals (D_n+1) are increased.

According to the present invention, when the n-th gate line is not activated, the (n+1)-th mean data voltage may be applied to the (n+1)-th gate line so that the LCD panel is pre-charged, thereby increasing the charging rate of the LCD panel. In addition, when the n-th gate line is not activated, the n-th mean data voltage may be applied to the n-th gate line so that the LCD panel is pre-charged, thereby increasing the charging rate of the LCD panel. Therefore, a pre-charging voltage corresponding to various data signals is applied to the gate line, thereby improving an image display quality of the LCD device.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A liquid crystal display device, comprising:
a liquid crystal display panel including:
a switching element formed in a region defined by adjacent gate and source lines; and
a liquid crystal capacitor electrically connected to the switching element;
a source driving part that converts data signals into data voltages;
an operating part that determines a mean data signal of the data signals;
a mean voltage generating part that converts the mean data signal into a mean data voltage; and
a pre-charging part that selectively applies the data voltages and the mean data voltage to the source lines.

2. The liquid crystal display device of claim 1, wherein the pre-charging part applies a mean data voltage of an (n+1)-th gate line to the source lines when an n-th gate line is not activated, and further wherein the pre-charging part applies data voltages of the (n+1)-th gate line to the source lines when the (n+1)-th gate line is activated.

3. The liquid crystal display device of claim 2, wherein the operating part determines the mean data signal as a mean of most frequent data signals of the (n+1)-th gate line.

4. The liquid crystal display device of claim 2, further comprising a memory storing the data signals by a predetermined unit, and wherein the operating part determines the mean data signal using the data signals of the (n+1)-th gate line stored in the memory.

5. The liquid crystal display device of claim 2, wherein the source driving part further comprises a latch part that temporarily stores the data signals, and the operating part determines the mean data signal using the data signals of the (n+1)-th gate line stored in the latch part.

6. The liquid crystal display device of claim 2, wherein the source driving part divides the data voltages into a plurality of groups, and outputs each of the groups.

7. The liquid crystal display device of claim 1, wherein the pre-charging part applies a mean data voltage of an n-th gate line to the source lines when the n-th gate line is not activated, and further wherein the pre-charging part applies data voltages of an (n+1)-th gate line to the source lines when the (n+1)-th gate line is activated.

8. The liquid crystal display device of claim 7, wherein the operating part determines the mean data signal as a mean of most frequent data signals of the data signals of the n-th gate line.

9. An apparatus for driving a liquid crystal display device including a liquid crystal display panel having a display region with a plurality of pixel parts between adjacent gate and source lines and a peripheral region surrounding the display region, the apparatus comprising:
a source driving part that converts data signals into data voltages;
an operating part that determines a mean data signal of the data signals;
a mean voltage generating part that converts the mean data signal into a mean data voltage; and
a pre-charging part that selectively applies the data voltages and the mean data voltage to the source lines.

10. The apparatus of claim 9, further comprising a gate circuit part that applies gate signals to the gate lines.

11. The apparatus of claim 10, wherein the gate circuit part is integrated in the peripheral region.

12. The apparatus of claim 9, wherein the pre-charging part applies a mean data voltage of an (n+1)-th gate line to the source lines when an n-th gate line is not activated, and further wherein the pre-charging part applies data voltages of the (n+1)-th gate line to the source lines when the (n+1)-th gate line is activated.

13. The apparatus of claim 12, wherein the operating part determines the mean data signal as a mean of most frequent data signals of the (n+1)-th gate line.

14. The apparatus of claim 12, further comprising a memory storing the data signals by a predetermined unit, and wherein the operating part determines the mean data signal using the data signals of the (n+1)-th gate line stored in the memory.

15. The apparatus of claim 12, wherein the source driving part further comprises a latch part that temporarily stores the data signals, and the operating part determines the mean data signal using the data signals of the (n+1)-th gate line stored in the latch part.

16. The apparatus of claim 9, wherein the pre-charging part applies a mean data voltage of an n-th gate line to the source lines when the n-th gate line is not activated, and further wherein the pre-charging part applies data voltages of an (n+1)-th gate line to the source lines when the (n+1)-th gate line is activated.

17. A method of driving a liquid crystal display device including a liquid crystal display panel having gate and source lines, the method comprising:
generating a mean data voltage corresponding to (n+1)-th data signals;
outputting the mean data voltage to the source lines when an n-th gate lines is not activated; and
outputting data voltages corresponding to the (n+1)-th data signals to the source lines when an (n+1)-th gate line is activated.

18. The method of claim 17, wherein the generating of the mean voltage further comprises:
determining a mean data signal using the (n+1)-th data signals that are stored; and
converting the mean data signal into a mean data voltage of analog type.

19. The method of claim 18, wherein the mean data voltage is a mean of most frequent data signals of the (n+1)-th data signals.

20. The method of claim 17, wherein the mean data voltage is a mean of most frequent data signals of the n-th data signals.
